(19) United States
(12) Patent Application Publication
(10) Pub. No.: US 2015/0212544 A1
(43) Pub. Date: Jul. 30, 2015

(54) Mounting Apparatus For Auxiliary Device

(71) Applicants: Shih-Hui Chen, Hsiang (TW); Chin-Tien Lin, Hsiang (TW)

(72) Inventors: Shih-Hui Chen, Hsiang (TW); Chin-Tien Lin, Hsiang (TW)

(21) Appl. No.: 14/609,773

(22) Filed: Jan. 30, 2015

Related U.S. Application Data
(63) Continuation-in-part of application No. 14/271,546, filed on May 7, 2014.
Application No. 14/271,546 is a continuation of application No. 12/727,878, filed on Mar. 19, 2010, now Pat. No. 8,741,403.

(51) Int. Cl. G06F 1/16; F16B 11/00; G06F 1/26; F16B 47/00

(52) U.S. Cl. CPC G06F 1/1632; F16B 47/00; F16B 11/006; G06F 1/26

(57) ABSTRACT

A mounting apparatus for an auxiliary device is provided. The mounting apparatus comprises a body made of a flexible material and includes a cavity with an opening for retaining the auxiliary device. In some embodiments, the auxiliary device comprises a battery and the mounting apparatus is configured to couple an external electronic device with the battery. In some embodiments, the auxiliary device comprises an expansion module suitably configured to expand functionality of the external electronic device. An opening is disposed at a bottom of the cavity so as to allow wires or cords of the auxiliary device to exit the cavity and pass to the external electronic device. Attaching elements, such as suction cups, are integrally formed on at least one lateral surface of the body for attaching the auxiliary device to the external electronic device. In some embodiments, the attaching elements may comprise an adhesive material.

### PRIORITY

This application is a continuation in part of and claims the benefit of, U.S. patent application Ser. No. 14/271,546, entitled “Flexible Disposition Apparatus,” filed on May 7, 2014, which is a continuation of, and claims the benefit of, U.S. Pat. No. 8,741,403, entitled “Flexible Disposition Apparatus,” issued on Jun. 3, 2014, the entirety of each of said applications being incorporated herein by reference and made a part of the present disclosure.

### FIELD

The field of the present disclosure generally relates to mounting devices. More particularly, the field of the invention relates to a mounting apparatus for an auxiliary device for electrically charging or expanding functions of an external electronic device.

### BACKGROUND

FIG. 1 illustrates a mounting base 1 for a wireless network card, as disclosed in R.O.C. Patent No. M360391. As shown in FIG. 1, the mounting base 1 comprises a support portion 11 formed at a bottom of the mounting base 1 and configured to support the wireless network card, an opening 14 on a side of the support portion 11 for passing a transmission line, a stop portion 12 extending from each of opposite sides of the mounting base 1, and an attaching element 13 configured to be installed onto a supportive surface, wherein the attaching element 13 is a suction cup. The attaching element 13 enables an end-user to advantageously mount the wireless network card to various supportive surfaces so as to optimize signal reception to the wireless network card. When better signal reception is desired, the end-user may conveniently use the attaching element 13 to affix the mounting base 1 to a location possessing better signal reception.

A drawback to the mounting base 1, however, is that the above-described components comprising the mounting base 1 must be fabricated separately and then assembled to form the mounting base. Thus, the manufacturing process tends to be relatively complicated. Another drawback is that the attaching element 13 may easily fall off the supportive surface, particularly if the surface is dirty, rough, or textured. Moreover, the mounting base 1 has a fixed shape and size, thus limiting the mounting base to being used only with objects having specific shapes and sizes. Still, another drawback to the mounting base 1 is that the opening 14 of the mounting base 1 may allow external electromagnetic interference to affect the wireless network card. What is needed, therefore, is a mounting apparatus which overcomes the shortcomings and deficiencies of prior art mounting devices, which provides a convenient, portable, and flexible mounting apparatus for auxiliary electronic devices.

### SUMMARY

A mounting apparatus for an auxiliary device is provided. The mounting apparatus comprises a body made of a flexible material and includes a cavity with an opening for retaining the auxiliary device. In some embodiments, the auxiliary device comprises a battery and the mounting apparatus is configured to couple at least one external electronic device with the battery. In some embodiments, the auxiliary device comprises a battery and the body further comprises a display module configured to display a power level of the battery. In some embodiments, the auxiliary device comprises at least one expansion module suitably configured to expand functionality of the external electronic device. The flexible material preferably comprises rubber, polyurethane, or a thermo-responsive material. In some embodiments, the flexible material may be doped with a metal filament so as to shield the auxiliary device from electromagnetic interference and draw heat away from the auxiliary device. An opening is disposed at a bottom of the cavity so as to allow wires or cords of the auxiliary device to exit the cavity and pass to an external electronic device. Attaching elements are integrally formed on at least one lateral surface of the body for attaching the auxiliary device to the external electronic device. In some embodiments, the attaching elements may be suction cups. In some embodiments, the attaching elements may comprise an adhesive material.

In an exemplary embodiment, a mounting apparatus for an auxiliary device comprises a body comprising a cavity with an opening for retaining the auxiliary device; an opening disposed at a bottom of the cavity so as to allow wires or cords of the auxiliary device to exit the cavity and pass to an external electronic device; and at least one attaching element integrally formed on at least one lateral surface of the body for attaching the auxiliary device to the external electronic device.

In another exemplary embodiment, the body is comprised of a flexible material which is doped with a metal filament so as to shield the auxiliary device from electromagnetic interference. In another exemplary embodiment, the at least one attaching element is a suction cup. In another exemplary embodiment, the at least one attaching element is an adhesive material. In another exemplary embodiment, the auxiliary device comprises a battery and the body further comprises a display module configured to display a power level of the battery. In another exemplary embodiment, the auxiliary device comprises a battery and the mounting apparatus is configured to couple at least one external electronic device with the battery. In another exemplary embodiment, the battery and the at least one external electronic device each includes a coil configured to inductively couple with one another so as to wirelessly charge, or supply power to, the at least one external electronic device. In another exemplary embodiment, the auxiliary device comprises at least one expansion module suitably configured to expand functionality of the external electronic device.

In an exemplary embodiment, an auxiliary device for coupling with an external electronic device comprises a rigid envelope containing the auxiliary device; a mounting apparatus disposed on at least one surface of the rigid envelope; a connection cable with a distal plug configured to couple the auxiliary device with the external electronic device; and a recess within the rigid envelope configured to receive and retain the connection cable and the distal plug.

In another exemplary embodiment, the mounting apparatus comprises a shape suitable for coupling the auxiliary device with the external electronic device. In another exemplary embodiment, the mounting apparatus comprises a multiplicity of suction cups disposed on a rear surface of the rigid envelope. In another exemplary embodiment, the mounting apparatus further comprises an adhesive portion suitably configured to cooperate with the multiplicity of suction cups so as to hold the auxiliary device fixed to a surface. In another exemplary embodiment, the mounting apparatus comprises mechanical attaching elements configured to cooperate with the multiplicity of suction cups and the adhesive portion so as to hold the auxiliary device fixed to the surface. In another exemplary embodiment, the mounting apparatus is comprised of a flexible material which is doped with a metal filament so as to shield the auxiliary device from electromagnetic interference and dissipate heat.

In another exemplary embodiment, the auxiliary device further comprises at least one port whereby a power cord may be inserted into the port and coupled with the auxiliary device. In another exemplary embodiment, the auxiliary device further comprises a power button disposed on a surface of the rigid envelope, whereby the auxiliary device may be turned on and off. In another exemplary embodiment, the auxiliary device comprises a battery configured to convey electrical power to the external electronic device. In another exemplary embodiment, the auxiliary device further comprises a power indicator incorporated into the rigid envelope and configured to indicate a power capacity of the battery. In another exemplary embodiment, the distal plug is configured to suitably interface with the external electronic device to which the auxiliary device is to be coupled. In another exemplary embodiment, the auxiliary device comprises at least one expansion module suitably adapted to expand the functionality of the external electronic device.

### BRIEF DESCRIPTION OF THE DRAWINGS

The drawings refer to embodiments of the present disclosure in which:

FIG. 1 illustrates a perspective view of a prior art mounting base;

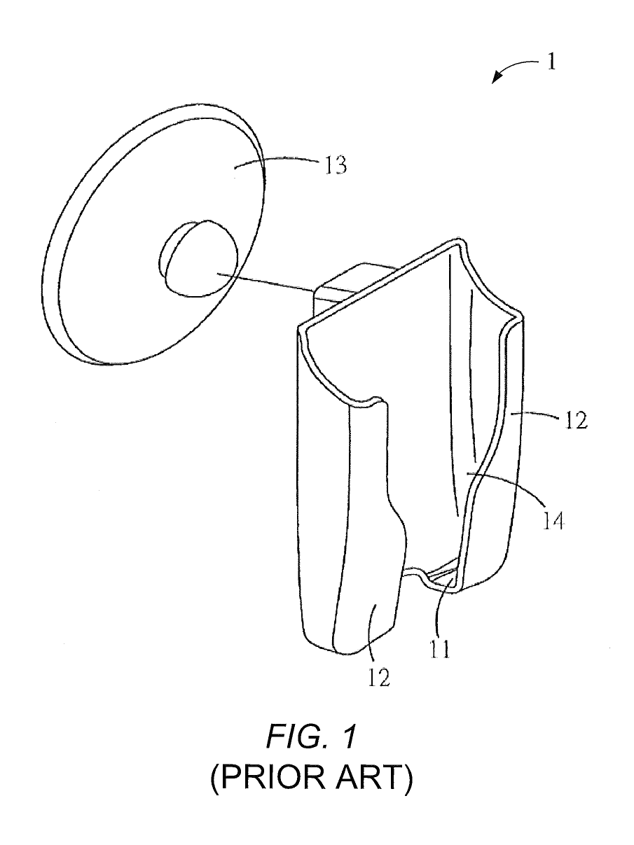

FIG. 2 illustrates a perspective view of an exemplary embodiment of a mounting apparatus for an auxiliary device in accordance with the present disclosure;

FIG. 3 illustrates a ghost view of an embodiment of a mounting apparatus for an auxiliary device in an exemplary use environment, according to the present disclosure;

FIG. 4 illustrates a sectional view of an embodiment of a mounting apparatus for an auxiliary device in an exemplary use environment, according to the present disclosure;

FIG. 5 illustrates a perspective view of an embodiment of a mounting apparatus for an auxiliary device in an exemplary use environment in accordance with the present disclosure;

FIG. 6 illustrates a sectional view of an embodiment of a mounting apparatus for an auxiliary device in an exemplary use environment, according to the present disclosure;

FIG. 7 illustrates a sectional view of an embodiment of a mounting apparatus for an auxiliary device in an exemplary use environment in accordance with the present disclosure;

FIG. 8 illustrates a perspective view of an embodiment of a mounting apparatus for an auxiliary device in an exemplary use environment, according to the present disclosure;

FIG. 9 illustrates a perspective view of an embodiment of a mounting apparatus for an auxiliary device in an exemplary use environment in accordance with the present disclosure;

FIG. 10 illustrates a sectional view of an embodiment of a mounting apparatus for an auxiliary device in an exemplary use environment, according to the present disclosure;

FIG. 11 illustrates a sectional view of an embodiment of a mounting apparatus for an auxiliary device in an exemplary use environment in accordance with the present disclosure; and

FIG. 12 illustrates a perspective view of an exemplary embodiment of an auxiliary battery comprising a rigid envelope and a mounting apparatus, according to the present disclosure.

While the present disclosure is subject to various modifications and alternative forms, specific embodiments thereof have been shown by way of example in the drawings and will herein be described in detail. The invention should be understood to not be limited to the particular forms disclosed, but on the contrary, the intention is to cover all modifications, equivalents, and alternatives falling within the spirit and scope of the present disclosure.

### DETAILED DESCRIPTION

In the following description, numerous specific details are set forth in order to provide a thorough understanding of the present disclosure. It will be apparent, however, to one of ordinary skill in the art that the present invention may be practiced without these specific details. In other instances, specific numeric references such as “first opening,” may be made. However, the specific numeric reference should not be interpreted as a literal sequential order but rather interpreted that the “first opening” is different than a “second opening.” Thus, the specific details set forth are merely exemplary. The specific details may be varied from and still be contemplated to be within the spirit and scope of the present disclosure. The term “coupled” is defined as meaning connected either directly to the component or indirectly to the component through another component. Further, as used herein, the terms “about,” “approximately,” or “substantially” for any numerical values or ranges indicate a suitable dimensional tolerance that allows the part or collection of components to function for its intended purpose as described herein.

In general, the present disclosure describes a mounting apparatus for an auxiliary device. The mounting apparatus comprises a body made of a flexible material and includes a cavity with an opening for retaining the auxiliary device. In some embodiments, the auxiliary device comprises a battery and the mounting apparatus is configured to couple at least one external electronic device with the battery. In some embodiments, the auxiliary device comprises a battery and the body further comprises a display module configured to display a power level of the battery. In some embodiments, the auxiliary device comprises at least one expansion module suitably configured to expand functionality of the external electronic device. The flexible material preferably comprises rubber, polyurethane, or a thermo-responsive material. In some embodiments, the flexible material may be doped with a metal filament so as to shield the auxiliary device from electromagnetic interference and dissipate heat from the auxiliary device. An opening is disposed at a bottom of the cavity so as to allow wires or cords of the auxiliary device to exit the cavity and pass to an external electronic device. Attaching elements are integrally formed on at least one lateral surface of the body for attaching the auxiliary device to the external electronic device. In some embodiments, the attaching elements may comprise suction cups. In some embodiments, the attaching elements may comprise an adhesive material.

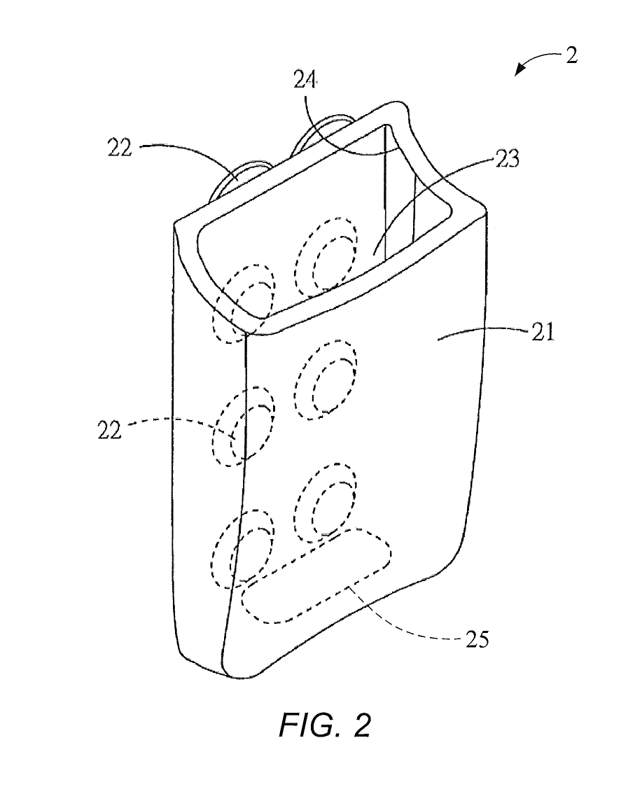

FIG. 2 illustrates a perspective view of an exemplary embodiment of a mounting apparatus 2 for an auxiliary device. The mounting apparatus 2 comprises a body 21 made of a flexible material. In some embodiments, the flexible material may be rubber, polyurethane (PU), or a thermo-responsive material. The mounting apparatus 2 further comprises at least one attaching element 22 integrally formed on at least one lateral surface of the body 21. In the embodiment shown in FIG. 2, each of the attaching elements 22 comprises a suction cup formed on a rear surface of the body 21. The body 21 further comprises a cavity 23 and an opening 24 configured to receive the auxiliary device. An opening 25 is disposed at the bottom of the cavity 23 so as to allow wires or cords of the auxiliary device to exit the cavity 23.

In some embodiments, the mounting apparatus 2 may be used to mount an auxiliary battery onto an electronic device, such as a laptop computer or mobile phone, so as to charge the electronic device. In other embodiments, the mounting apparatus 2 may be used to mount an auxiliary device, such as by way of non-limiting example, a wireless network card or an expansion module, so as to add network access or additional functionality to an electronic device, such as a laptop computer or mobile phone.

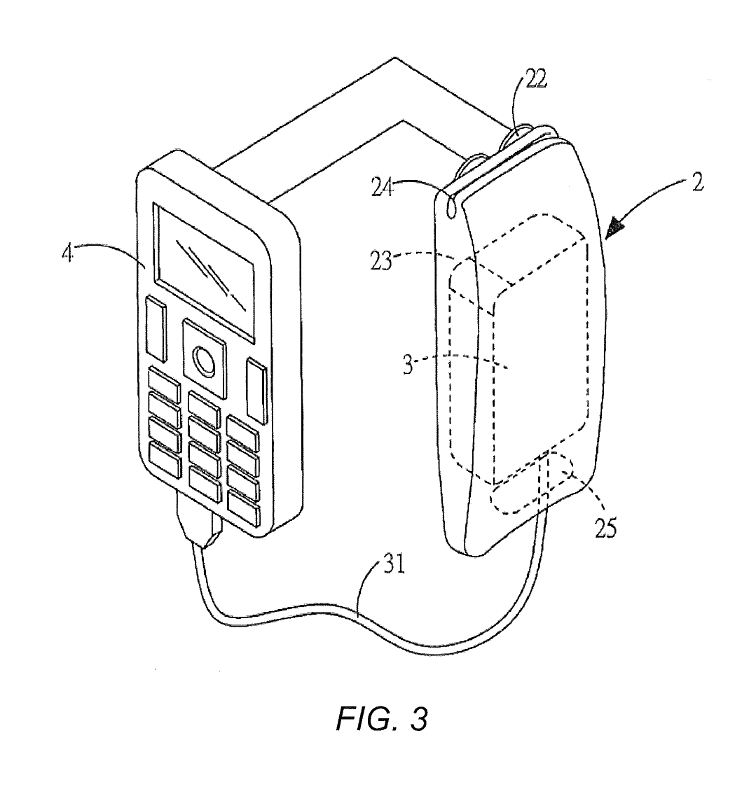

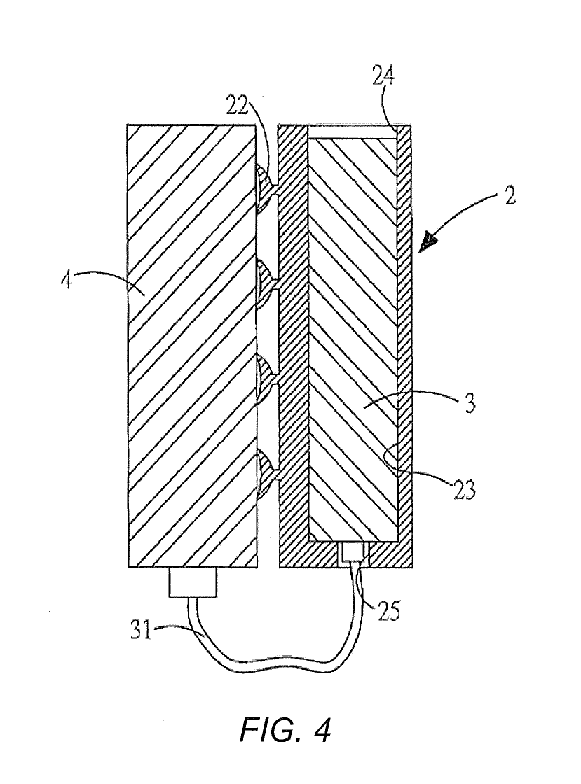

FIG. 3 illustrates a ghost view of an embodiment of the mounting apparatus 2 in an exemplary use environment, wherein the mounting apparatus 2 is used to couple an auxiliary battery 3 with an electronic device 4. In the embodiment illustrated FIGS. 3 and 4, the electronic device 4 comprises a mobile phone or a personal digital assistant (PDA). The mounting apparatus 2 illustrated in FIGS. 3-4 is substantially similar to the mounting apparatus shown in FIG. 2, with the exception that the mounting apparatus of FIG. 3 comprises an opening 24 which may be closed so as to retain the auxiliary battery 3 within the cavity 23. It is envisioned that the mounting apparatus 2 comprises a flexible material which facilitates opening and closing of the opening 24, thereby enabling an end-user to easily insert the auxiliary battery 3 into the cavity 23. As further illustrated in FIG. 3, a transmission component 31 passes through the opening 25 in the bottom of the mounting apparatus 2 and couples the auxiliary battery 3 with the electronic device 4. It will be appreciated that the transmission components 31 comprises a power cord whereby the auxiliary battery 3 may be used to charge the electronic device 4. It will be further appreciated that the auxiliary battery 3 generally operates in addition to a battery within the electronic device 4, and thus the mounting apparatus 2 facilitates using the auxiliary battery 3 to extend the effective battery life of the electronic device 4.

FIG. 4 illustrates a sectional view of the mounting apparatus 2 coupled with the electronic device 4. As shown in FIG. 4, the auxiliary battery 3 is contained within the cavity 23, and the power cord 31 exits the opening 25, such that the auxiliary battery 3 is coupled with the electronic device 4. The mounting apparatus 2 is affixed to a rear surface of the electronic device 4 by way of the attaching elements 22. In the illustrated embodiment of FIGS. 3 and 4, the attaching elements 22 are suction cups although other forms of the attaching elements 22 may be contemplated within the spirit and scope of the present disclosure. Moreover, it is contemplated that although the auxiliary battery 3 is shown within the cavity 23 and the mounting apparatus 2 is shown attached to the electronic device 4, it will be appreciated that equivalently the electronic device 4 may be enclosed within the cavity 23 and the mounting apparatus 2 may be affixed to a surface of the auxiliary battery 3.

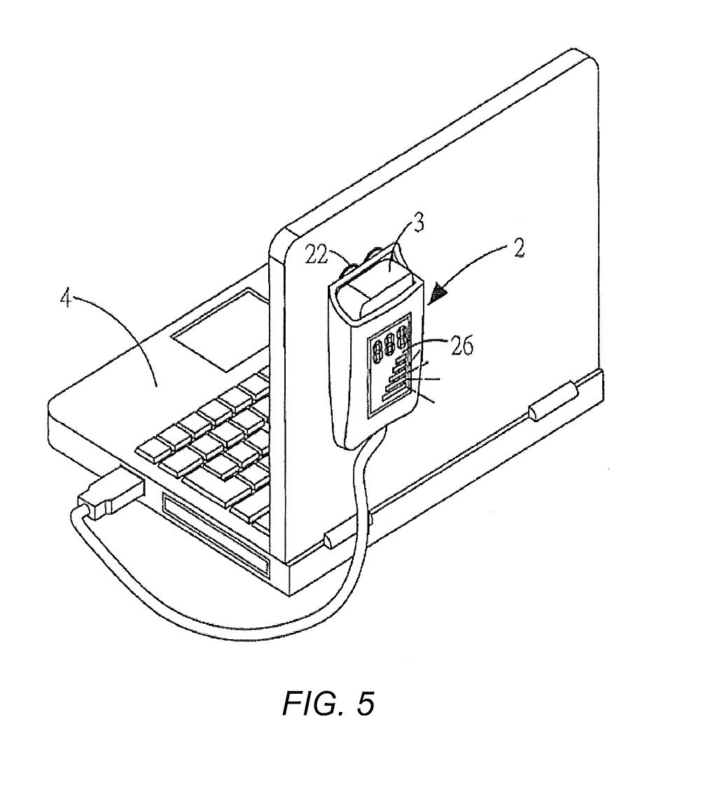

FIG. 5 illustrates a perspective view of an embodiment of a mounting apparatus 2 for an auxiliary battery 3 coupled to a notebook computer 4. The mounting apparatus 2 is affixed to a rear surface of the notebook computer 4 by way of the attaching elements 22 in the form of suction cups. The embodiment of the mounting apparatus 2 illustrated in FIG. 5 is substantially similar to the mounting apparatus illustrated in FIG. 2, with the exception that the mounting apparatus 2 of FIG. 5 further comprises a display module 26 incorporated into an exterior surface of the body 21. Similar to the embodiment of FIGS. 3-4, the auxiliary battery 3 illustrated in FIG. 5 is utilized to extend the battery capacity of the notebook computer 4 by way of a power cord coupling the auxiliary battery 3 to the notebook computer 4. Accordingly, the display module 26 is electrically coupled to the auxiliary battery 3 and configured to display the power level within the auxiliary battery 3. In some embodiments, the display module 26 is configured to account for the power level of an internal battery within the notebook computer 4, and thus the display module 26 indicates to the end-user a total battery capacity available to the notebook computer 4. In some embodiments, the display module 26 may further comprise a flexible, thermo-responsive material, whereby a detected temperature of the auxiliary battery 3 may be displayed in addition to the power level within the battery.

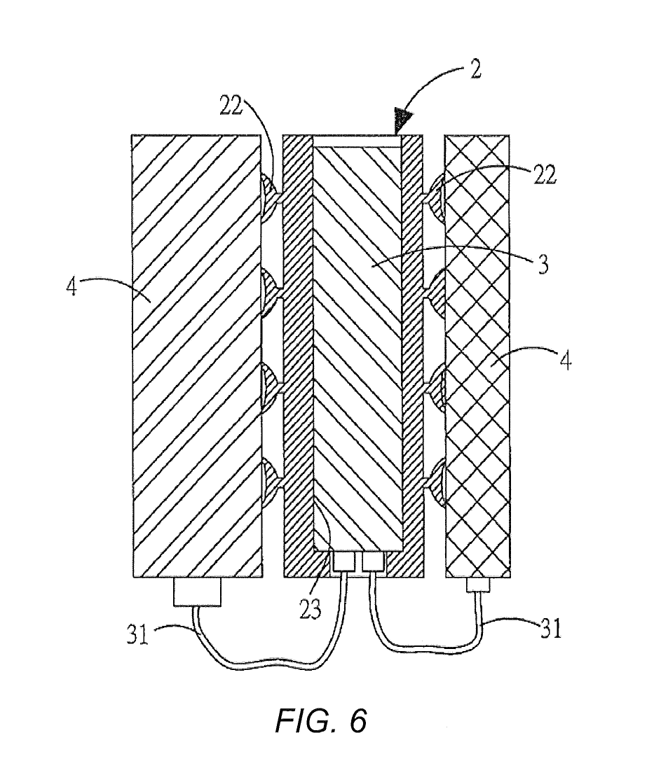

FIG. 6 illustrates a sectional view of an embodiment of a mounting apparatus 2 for an auxiliary battery 3 coupled to two electronic devices 4. The mounting apparatus 2 illustrated in FIG. 6 is substantially similar to the mounting apparatus illustrated in FIG. 4, with the exception that the mounting apparatus 2 of FIG. 6 comprises a multiplicity of attaching elements 22 disposed on opposite surfaces of the body 21. The embodiment of the mounting apparatus illustrated in FIG. 6 facilitates simultaneously coupling the auxiliary battery 3 to electronic devices 4 so as to charge, or extend the effective battery capacity of the two devices. The multiplicity of attaching elements 22 facilitates affixing the two electronic devices 4 on opposite sides of the body 21, such that the mounting apparatus 2 is effectively “sandwiched” between the devices. It is envisioned that the two electronic devices 4 illustrated in FIG. 6 may comprise any of the electronic devices illustrated in FIGS. 2-5. For example, one of the electronic devices 4 in FIG. 6 may be the mobile phone of FIG. 3 while the second of the electronic devices 4 may be the notebook computer of FIG. 5. Moreover, although the attaching elements 22 are illustrated in FIG. 6 as comprising suction cups, the attaching elements 22 should not be construed as being limited to suction cups, but rather the attaching elements 22 may be comprised of any mechanism whereby the electronic devices 4 may be removeably affixed to the mounting apparatus 2.

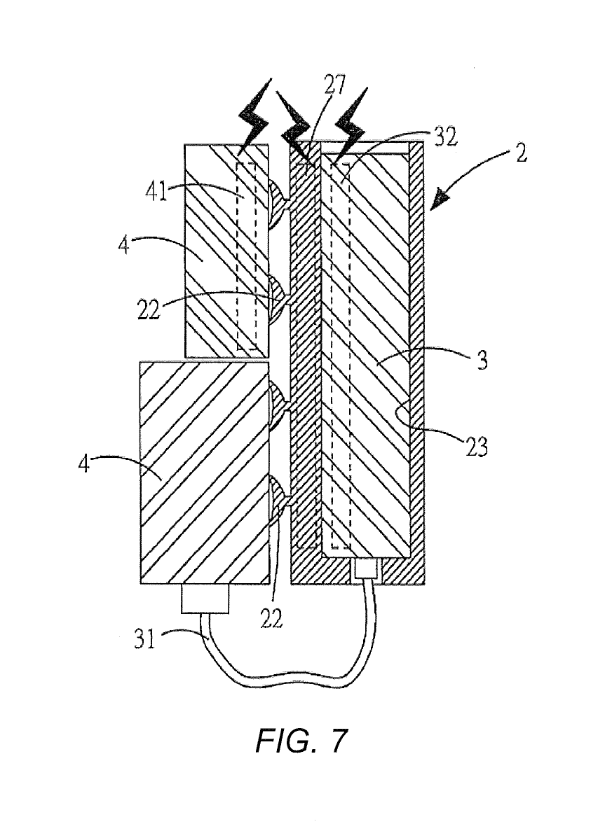

It will be recognized that in some embodiments, the mounting apparatus 2 may be used for attaching and affixing a plurality of electronic devices. FIG. 7 illustrates a sectional view of an embodiment of a mounting apparatus 2 for an auxiliary battery 3 in an exemplary use environment wherein the auxiliary battery 3 is used to simultaneously charge two electronic devices 4. The mounting apparatus 2 illustrated in FIG. 7 is substantially similar to the mounting apparatus illustrated in FIG. 4, with the exception that the mounting apparatus 2 of FIG. 7 comprises a coil 27 embedded within a rear wall of the body 21, thereby placing the coil 27 near the electronic devices 4. Further, the auxiliary battery 3 illustrated in FIG. 7 comprises an internal coil 32. It will be appreciated that the coils 27 and 32 facilitate inductively coupling with a coil 41 within at least one of the electronic devices 4 so as to wirelessly charge, or supply power to, the electronic devices 4. In the embodiment illustrated in FIG. 7, the auxiliary battery 3 simultaneously charges one of the two electronic devices 4 by way of the coils 27, 32, 41, and charges the other of the two electronic devices 4 by way of the power cord 31. Similar to the embodiments discussed in connection with FIGS. 2-6, the mounting apparatus 2 of FIG. 7 is affixed to the two electronic devices 4 by way of the attaching elements 22 implemented in the form of suction cups.

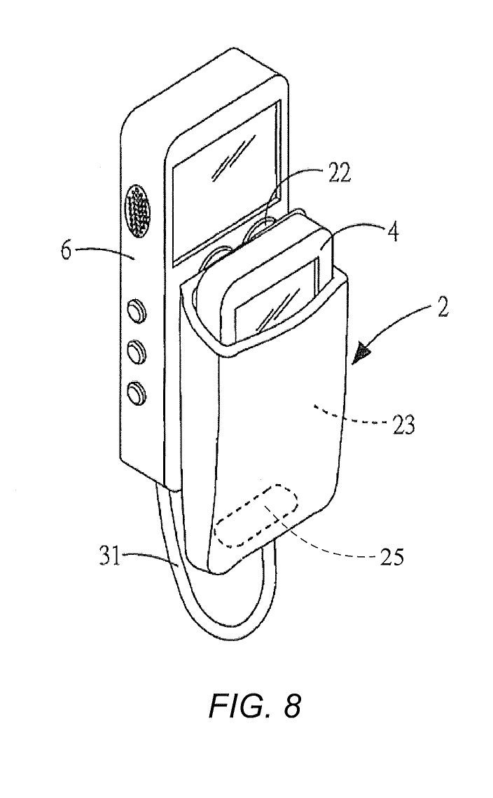

It should be understood that the aforementioned embodiments of the mounting apparatus 2 are not limited solely to charging internal batteries of electronic devices, but rather any of the aforementioned embodiments of the mounting apparatus 2 may be utilized for expanding various functions of the electronic devices, such as, by way of non-limiting example, by coupling the electronic devices with any of a variety of expansion modules. FIG. 8 illustrates a perspective view of the mounting apparatus 2 of FIG. 2 in an exemplary use environment, wherein an electronic device 4 is coupled to an expansion module 6. As shown in FIG. 8, the electronic device 4 is seated within the cavity 23, and the expanding module 6 is affixed to the mounting apparatus 2 by way of the attaching elements 22 implemented in the form of suction cups. The transmission component 31 is implemented as a data cable which passes through the opening 25 in the bottom of the cavity 23 and couples the electronic device 4 with the expansion module 6. It is contemplated that the electronic device 4 may be any mobile device, such as a mobile phone, a translation device, a laptop computer, a notebook computer, a personal digital assistant (PDA), a portable GPS device, a portable multimedia player, and the like. It is contemplated that upon coupling with the electronic device 4 with the expansion module 6 by way of the data cable 31, the expansion module 6 generally imparts additional functionality to the electronic device 4, such as by way of non-limiting example, GPS functions, video recording functions, digital video playing functions, wireless communication functions, signal broadcasting functions, and the like.

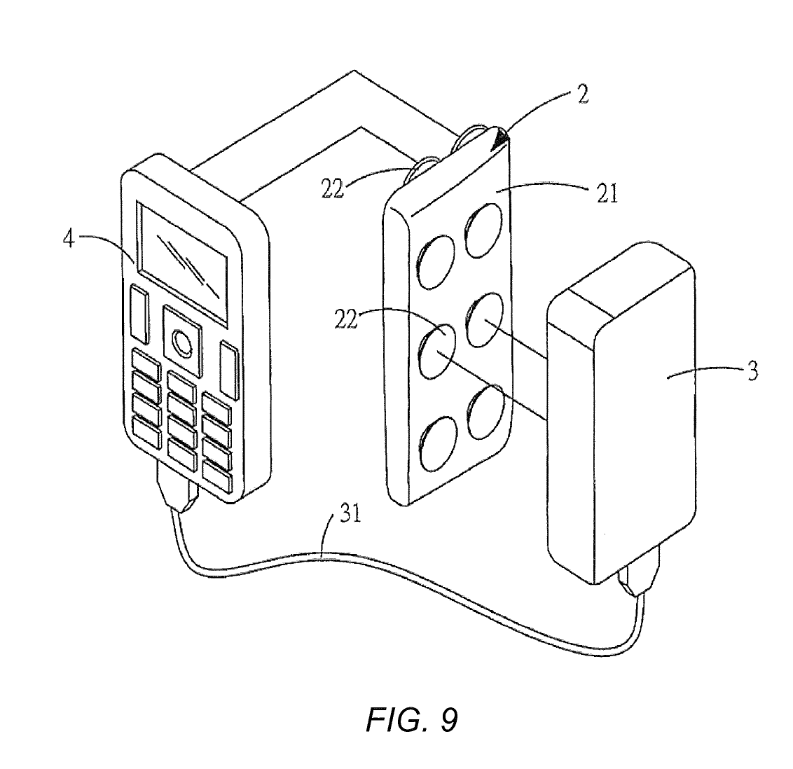

FIG. 9 illustrates a perspective view of an embodiment of a mounting apparatus 2 for coupling an auxiliary battery 3 with an electronic device 4. The mounting apparatus 2 comprises a body 21 having a multiplicity of attaching elements 22 disposed on opposite surfaces of the body 21. Preferably, the body 21 is made of a flexible material, such as rubber, polyurethane (PU), or a thermo-responsive material. A transmission component 31 in the form of a power cord couples the auxiliary battery 3 with the electronic device 4, such that the auxiliary battery 3 operates in addition to a battery within the electronic device 4, and thus extends the effective total battery life of the electronic device 4. In the embodiment illustrated in FIG. 9, the auxiliary battery 3 is affixed to the mounting apparatus 2 by way of the attaching elements 22 disposed on one side of the mounting apparatus, and the mounting apparatus 2 is affixed to the electronic device 4 by way of the attaching elements 22 on the other side of the mounting apparatus. It will be appreciated that once the auxiliary battery 3 is attached to the electronic device 4, the mounting apparatus 2 is effectively “sandwiched” between the electronic device 4 and the auxiliary battery 3.

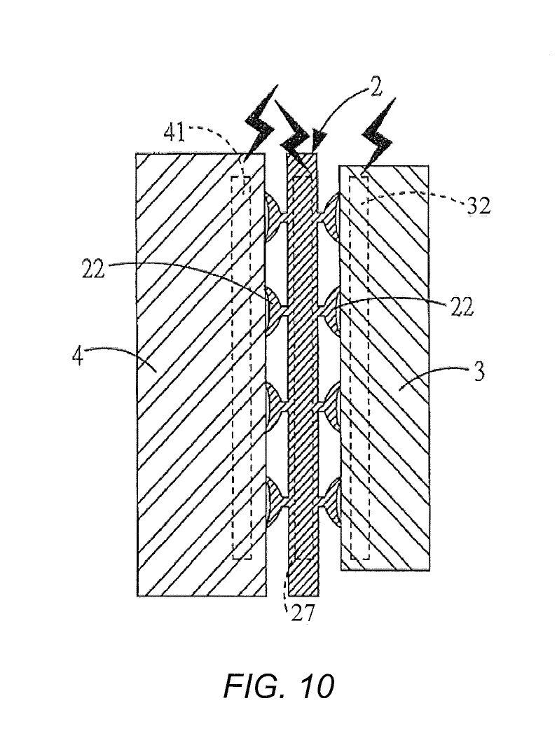

FIG. 10 illustrates a sectional view of an embodiment of a mounting apparatus 2 for coupling an auxiliary battery 3 with an electronic device 4 in absence of the power cord 31. The mounting apparatus 2 illustrated in FIG. 10 is substantially similar to the mounting apparatus illustrated in FIG. 9, with the exception that the mounting apparatus 2 of FIG. 10 comprises a coil 27 embedded within the body 21. Further, the auxiliary battery 3 illustrated in FIG. 10 comprises an internal coil 32, and the electronic device 4 comprises an internal coil 41. It will be appreciated that the coils 27, 32, 41 facilitate inductively coupling the auxiliary battery 3 to the electronic device 4 so as to wirelessly charge, or supply power to, the electronic device 4.

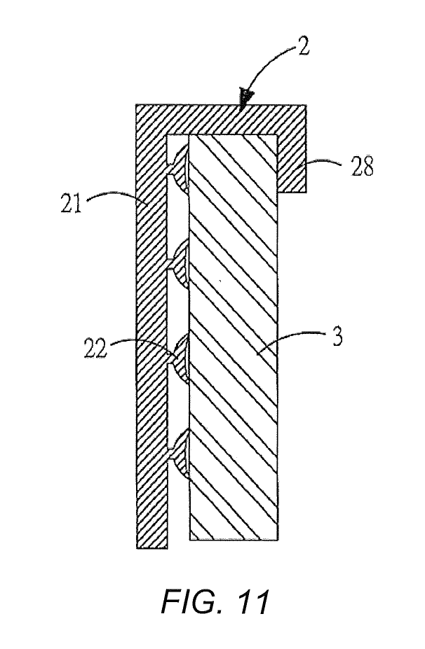

FIG. 11 illustrates a sectional view of an embodiment of a mounting apparatus 2 for an auxiliary battery 3 for charging electrical devices. The mounting apparatus 2 comprises a body 21 having a multiplicity of attaching elements 22 disposed on a surface of the body, and a hook portion 28 integrally formed at a top end of the body 21. Preferably, the body 21 is made of a flexible material, such as rubber, polyurethane (PU), or a thermo-responsive material. The attaching elements 22 are configured for affixing the auxiliary battery 3 to the body 21, and the hook portion 28 is configured to retain at least a portion of the auxiliary battery 3 so as to keep the battery affixed to the attaching elements 22. Thus, the attaching elements 22 and the hook portion 28 cooperate to keep the auxiliary battery 3 fastened to the body 21, as shown in FIG. 11, while facilitating easy removal of the auxiliary battery 3 from the body 21 by an end-user. It will be appreciated that the embodiment illustrated in FIG. 11 lacks the cavity 23, discussed in connection with FIGS. 2-8, and thus provides a greater degree of accessibility to the auxiliary battery 3 than the embodiments discussed in connection with FIGS. 2-8. The greater degree of accessibility facilitates coupling the mounting apparatus 2 with different auxiliary batteries possessing a wide variety of shapes and sizes, as well as providing accessibility to various ports, or plug-ins, on the batteries for receiving the transmission component 31. Thus, the mounting apparatus 2 illustrated in FIG. 11 is not limited to being used with one particular type and shape of battery, but rather the mounting apparatus 2 may be used with various other types and shapes of auxiliary batteries, each of which having power ports in different locations, such that the auxiliary battery operates in addition to internal batteries within various electronic devices to which the mounting apparatus 2 may be coupled.

It should be understood that in each of the embodiments discussed above in connection with FIGS. 2-11, the body 21 and the attaching elements 22 of the mounting apparatus 2 are integrally formed, such that an overall manufacturing procedure is simplified relative to conventional mounting devices. It is contemplated that the flexible material comprising the mounting apparatus 2 may be formed into any shape suitable for coupling together different devices and objects. Further, in some embodiments the flexible material comprising any of the above-discussed embodiments may be doped with a metal filament so as to provide the mounting apparatus with electromagnetic interference (EMI) shielding properties, as well as providing the mounting apparatus with heat dissipation properties.

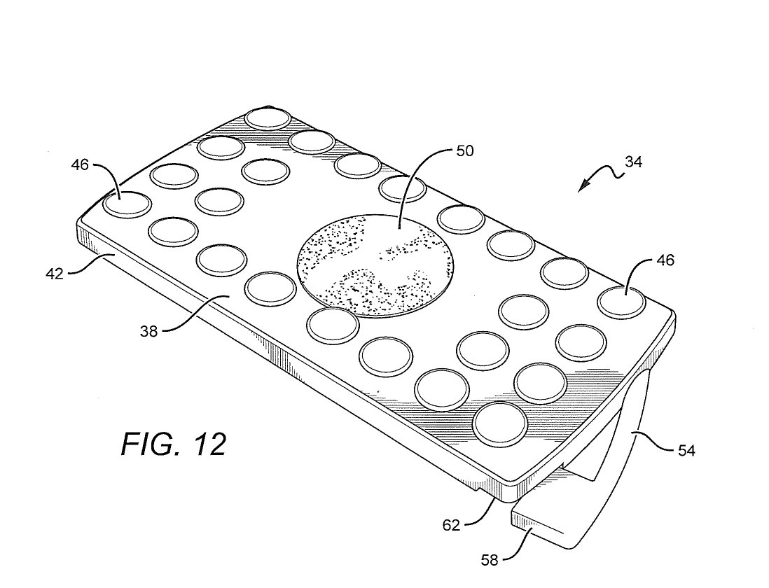

FIG. 12 illustrates a perspective view of an exemplary embodiment of an auxiliary battery 34 which comprises a rigid envelope 42 and a mounting apparatus 38 suitably configured for affixing the auxiliary battery 34 to any of the above-discussed electronic devices. In the embodiment of FIG. 12, the mounting apparatus 38 comprises a multiplicity of suction cups 46 disposed on a rear surface of the auxiliary battery 34. Preferably, the suction cups 46 are comprised of a flexible material, such as rubber, polyurethane (PU), or other similar material. It will be appreciated that while the suction cups 46 are suitable for affixing the auxiliary battery 34 to various smooth surfaces, such as a rear surface of a mobile phone or laptop computer, many surfaces are textured, or rough, and thus the suction cups 46 may be inappropriate for such surfaces. Accordingly, the mounting apparatus 38 further comprises an adhesive portion 50 suitably configured to cooperate with the suction cups 46 so as to hold the auxiliary battery 34 fixed to all surfaces, including those surfaces comprising a texture, or otherwise being rough. In some embodiments, however, the mounting apparatus 38 may comprise mechanical attaching elements in addition to the suction cups 46 and the adhesive portion 50, such as by way of non-limiting example, Velcro strips, or any of a variety of straps, whereby the auxiliary battery 34 may be attached to an electronic device. It is contemplated, that in other embodiments the mounting apparatus 38 may comprise any attaching elements suitably configured to fasten the auxiliary battery 34 to various surfaces without deviating from the spirit and scope of the present disclosure.

The rigid envelope 42 generally operates as an exterior shell which protects the auxiliary battery 34 within the envelope, as well as consolidating and protecting any additional circuitry or circuit boards that may be coupled to the auxiliary battery 34. In some embodiments, the rigid envelope 42 further comprises at least one charging port, whereby a power cord may be inserted into the port and coupled with the auxiliary battery 34 so as to charge the battery. Further, some embodiments of the auxiliary batter 34 may comprise a power indicator incorporated into the rigid envelope 42 and configured to indicate a power capacity of the auxiliary battery. As will be appreciated, the auxiliary battery 34 further comprises a power button which may be disposed on a front surface (not shown), or any of the side surfaces, of the rigid envelope 42, whereby an end-user may turn the auxiliary battery 34 on and off.

As shown in FIG. 12, the auxiliary battery 34 further comprises a connection cable 54 with a distal plug 58, both of which being receivable by a protective recess 62 within the rigid envelope 42. The connection cable 54 is substantially similar to the transmission component 31 discussed in connection with FIGS. 2-11, with the exception that the connection cable 54 is integral to the auxiliary battery 34, and thus is not removable from the rigid envelope 42. In some embodiments, however, the connection cable 54 may be removable from the rigid envelope 42. The distal plug 58 is configured to suitably interface with a specific electronic device to which the auxiliary battery 34 is to be coupled. Accordingly, the form of the distal plug 58 will depend upon the specific configuration of the ports of the electronic device. It is contemplated, therefore, that the distal plug 58 may be adapted to a wide variety of ports of various electronic devices without departing from the spirit and scope of the present disclosure.

It should be understood that in the embodiment discussed above in connection with FIG. 12, the flexible material comprising the mounting apparatus 38 may be formed into any shape suitable for coupling the auxiliary battery 34 together with any of various devices and objects. It should be further understood that the embodiment illustrated in FIG. 12 need not be limited to charging electronic devices, or extending the power capacity of external batteries, but rather the embodiment illustrated in FIG. 12 may be suitably adapted so as to expand the functionality of various electronic devices. It is contemplated that, in some embodiments, the battery discussed with respect to Fig, 12 may be replaced with an expansion module, as discussed in connection with FIG. 8, whereby additional functionality may be imparted to electronic devices, such as by way of non-limiting example, GPS functions, video recording functions, digital video playing functions, wireless communication functions, signal broadcasting functions, and the like. Further, in some embodiments the flexible material comprising the mounting apparatus 38 may be doped with a metal filament so as to provide the mounting apparatus with electromagnetic interference (EMI) shielding properties, as well as providing the mounting apparatus 38 with heat dissipation properties.

While the invention has been described in terms of particular variations and illustrative figures, those of ordinary skill in the art will recognize that the invention is not limited to the variations or figures described. In addition, where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially as described above. To the extent there are variations of the invention, which are within the spirit of the disclosure or equivalent to the inventions found in the claims, it is the intent that this patent will cover those variations as well. Therefore, the present disclosure is to be understood as not limited by the specific embodiments described herein, but only by scope of the appended claims.

What is claimed is:

1. A mounting apparatus for an auxiliary device, comprising:
a body comprising a cavity with an opening for retaining the auxiliary device;
an opening disposed at a bottom of the cavity so as to allow wires or cords of the auxiliary device to exit the cavity and pass to an external electronic device; and
at least one attaching element integrally formed on at least one lateral surface of the body for attaching the auxiliary device to the external electronic device.

2. The apparatus of claim 1, wherein the body is comprised of a flexible material which is doped with a metal filament so as to shield the auxiliary device from electromagnetic interference.

3. The apparatus of claim 1, wherein the at least one attaching element is a suction cup.

4. The apparatus of claim 1, wherein the at least one attaching element is an adhesive material.

5. The apparatus of claim 1, wherein the auxiliary device comprises a battery and the body further comprises a display module configured to display a power level of the battery.

6. The apparatus of claim 1, wherein the auxiliary device comprises a battery and the mounting apparatus is configured to couple at least one external electronic device with the battery.

7. The apparatus of claim 6, wherein the battery and the at least one external electronic device each includes a coil configured to inductively couple with one another so as to wirelessly charge, or supply power to, the at least one external electronic device.

8. The apparatus of claim 1, wherein the auxiliary device comprises at least one expansion module suitably configured to expand functionality of the external electronic device.

9. An auxiliary device for coupling with an external electronic device, comprising:
a rigid envelope containing the auxiliary device;
a mounting apparatus disposed on at least one surface of the rigid envelope;
a connection cable with a distal plug configured to couple the auxiliary device with the external electronic device; and
a recess within the rigid envelope configured to receive and retain the connection cable and the distal plug.

10. The auxiliary device of claim 9, wherein the mounting apparatus comprises a shape suitable for coupling the auxiliary device with the external electronic device.

11. The auxiliary device of claim 9, wherein the mounting apparatus comprises a multiplicity of suction cups disposed on a rear surface of the rigid envelope.

12. The auxiliary device of claim 11, wherein the mounting apparatus further comprises an adhesive portion suitably configured to cooperate with the multiplicity of suction cups so as to hold the auxiliary device fixed to a surface.

13. The auxiliary device of claim 12, wherein the mounting apparatus comprises mechanical attaching elements configured to cooperate with the multiplicity of suction cups and the adhesive portion so as to hold the auxiliary device fixed to the surface.

14. The auxiliary device of claim 11, wherein the mounting apparatus is comprised of a flexible material which is doped with a metal filament so as to shield the auxiliary device from electromagnetic interference and dissipate heat.

15. The auxiliary device of claim 9, further comprising at least one port whereby a power cord may be inserted into the port and coupled with the auxiliary device.

16. The auxiliary device of claim 9, further comprising a power button disposed on a surface of the rigid envelope, whereby the auxiliary device may be turned on and off.

17. The auxiliary device of claim 9, wherein the auxiliary device comprises a battery configured to convey electrical power to the external electronic device.

18. The auxiliary device of claim 17, further comprising a power indicator incorporated into the rigid envelope and configured to indicate a power capacity of the battery.

19. The auxiliary device of claim 9, wherein the distal plug is configured to suitably interface with the external electronic device to which the auxiliary device is to be coupled.

20. The auxiliary device of claim 9, wherein the auxiliary device comprises at least one expansion module suitably adapted to expand the functionality of the external electronic device.
